(19) United States
(12) Patent Application Publication
(10) Pub. No.: US 2026/0158926 A1
(43) Pub. Date: Jun. 11, 2026

(54) SYSTEMS AND METHODS FOR LOOPING KALMAN FILTER ESTIMATION OF VEHICLE DRIVELINE VIBRATION

(71) Applicant: FCA US LLC, Auburn Hills, MI (US)

(72) Inventors: Nadirsh Patel, Auburn Hills, MI (US); Cristian Rostiti, Auburn Hills, MI (US)

(21) Appl. No.: 18/972,069

(22) Filed: Dec. 6, 2024

(51) Int. Cl. B60L 3/00; B60L 15/20

(52) U.S. Cl. CPC B60L 3/0061; B60L 15/20; B60L 2270/00

(57) ABSTRACT

A driveline vibration management system and method for an electrified vehicle each include a set of sensors configured to measure parameters of the electrified vehicle, each measured parameter relating to an electrified powertrain and a driveline of the electrified vehicle and a control system configured to initiate a looping Kalman filter for N time samples, where N is an integer greater than zero and is based on a delay between the control system and the electrified powertrain and the driveline and, after the N time samples, utilize the looping Kalman filter to (i) estimate a state of the electrified powertrain and the driveline and (ii) update previous estimate states of the electrified powertrain and the driveline and utilize an advance controller to control the electrified powertrain and the driveline based on their respective estimated states.

### FIELD

The present application generally relates to vehicle driveline vibration management and, more particularly, to systems and methods of estimation and control of a driveline characterized by stiffness and lash affected by measurement and actuation time delays.

### BACKGROUND

Electrified vehicles often include multiple rotating shafts and one or more disconnect clutches, resulting in many torque paths and gear sets that are characterized by stiffness and lash. Minimizing driveline vibrations is important for performance, component life, and customer perceived quality. Some models assume these shafts to be stiff or rigid, but in reality they can bend and thus act like springs. Torque sensors could be added for direct measurement, but this would substantially increase vehicle costs. Additionally, there are various measurement/actuation delays that limit the effectiveness of advance control algorithms that attempt to compensate for lash and other non-linearity. Conventional solutions to this problem ignore these delays or handle them locally using lower power controllers and simpler, less accurate control schemes (e.g., feedback-based control). Accordingly, while such conventional driveline vibration management systems do work for their intended purpose, there exists an opportunity for improvement in the relevant art.

### SUMMARY

According to one example aspect of the invention, a driveline vibration management system for an electrified vehicle is presented. In one exemplary implementation, the driveline vibration management system comprises a set of sensors configured to measure parameters of the electrified vehicle, each measured parameter relating to an electrified powertrain and a driveline of the electrified vehicle and a control system configured to initiate a looping Kalman filter for N time samples, where N is an integer greater than zero and is based on a delay between the control system and the electrified powertrain and the driveline and, after the N time samples, utilize the looping Kalman filter to (i) estimate a state of the electrified powertrain and the driveline and (ii) update previous estimate states of the electrified powertrain and the driveline, and utilize an advance controller to control the electrified powertrain and the driveline based on their respective estimated states.

In some implementations, N is based on time sample delays M and A, wherein M represents a number of time samples corresponding to a measurement delay associated with the set of sensors and the control system, and wherein A represents a number of time samples corresponding to an actuation delay associated with the control system and the electrified powertrain and the driveline. In some implementations, M and A are both integers greater than zero and N equals (M+A). In some implementations, the control system is configured to initialize the looping Kalman filter upon wakeup of the electrified vehicle or the control system. In some implementations, the control system is configured to initialize the looping Kalman filter by initializing its estimation to an origin value for the first (M+A) time samples. In some implementations, the origin value is zero.

In some implementations, the advance controller is designed to control a system without looping delays and therefore the advance controller needs the looping Kalman filter to compensate for the looping delays. In some implementations, the control system comprises a supervisory electronic control unit (ECU) configured to supervise and provide references using the looping Kalman filter and the advance controller to a secondary ECU, and wherein the secondary ECU is configured to actuated the references from the supervisory ECU and to measure and send information back to the supervisory ECU. In some implementations, the secondary ECU is a motor controller for one or more electric motors of the powertrain. In some implementations, the powertrain includes separate first and second electric motors that are selectively connectable to the driveline to achieve both a single-motor drive mode and a dual-motor drive mode.

According to another example aspect of the invention, a driveline vibration management method for an electrified vehicle is presented. In one exemplary implementation, the driveline vibration management method comprises receiving, by a control system of the electrified vehicle and from a set of sensors of the electrified vehicle, measured parameters of the electrified vehicle, each measured parameter relating to an electrified powertrain and a driveline of the electrified vehicle, initiating, by the control system, a looping Kalman filter for N time samples, where N is an integer greater than zero and is based on a delay between the control system and the electrified powertrain and the driveline and, after the N time samples, utilizing, by the control system, the looping Kalman filter to (i) estimate a state of the electrified powertrain and the driveline and (ii) update previous estimate states of the electrified powertrain and the driveline, and utilizing, by the control system, an advance controller to control the electrified powertrain and the driveline based on their respective estimated states.

In some implementations, N is based on time sample delays M and A, wherein M represents a number of time samples corresponding to a measurement delay associated with the set of sensors and the control system, and wherein A represents a number of time samples corresponding to an actuation delay associated with the control system and the electrified powertrain and the driveline. In some implementations, wherein M and A are both integers greater than zero and N equals (M+A). In some implementations, the control system is configured to initialize the looping Kalman filter upon wakeup of the electrified vehicle or the control system. In some implementations, the control system is configured to initialize the looping Kalman filter by initializing its estimation to an origin value for the first (M+A) time samples. In some implementations, the origin value is zero.

In some implementations, the advance controller is designed to control a system without looping delays and therefore the advance controller needs the looping Kalman filter to compensate for the looping delays. In some implementations, the control system comprises a supervisory ECU configured to supervise and provide references using the looping Kalman filter and the advance controller to a secondary ECU, and wherein the secondary ECU is configured to actuated the references from the supervisory ECU and to measure and send information back to the supervisory ECU. In some implementations, the secondary ECU is a motor controller for one or more electric motors of the powertrain. In some implementations, the powertrain includes separate first and second electric motors that are selectively connectable to the driveline to achieve both a single-motor drive mode and a dual-motor drive mode.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example driveline vibration management system according to the principles of the present application;

FIG. 2 is a diagram of an example lumped-parameters model for an example two-motor configuration of the electrified vehicle according to the principles of the present application;

FIG. 3 is a functional block diagram of an example system architecture for the driveline vibration management system according to the principles of the present application; and

FIG. 4 is a flow diagram of an example looping Kalman filter driveline vibration estimation method for an electrified vehicle according to the principles of the present application.

### DESCRIPTION

As previously discussed, electrified vehicles often include multiple rotating shafts and one or more disconnect clutches, resulting in many torque paths and gear sets that are characterized by stiffness and lash. Minimizing driveline vibrations is important for performance, component life, and customer perceived quality of electrified vehicles. Some models assume these shafts to be stiff or rigid, but in reality they can bend and thus act like springs. Torque sensors could be added for direct measurement, but this would substantially increase vehicle costs. Additionally, there are various measurement/actuation delays that limit the effectiveness of advance control algorithms that attempt to compensate for lash and other non-linearity. Conventional solutions to this problem ignore the delays, apply the control with larger time frames (lower frequency) such that small delays can be ignored, or rely on lower power local controllers and simpler, less accurate control techniques, such as closed-loop feedback type controls (e.g., proportional-integral-derivative, or PID control).

Accordingly, a new control strategy is presented herein that is based on a traditional Kalman filter estimation architecture, which is enhanced by using a looping strategy to estimate the dynamics up to a given horizon length (into the future). The parameters estimated using this looping Kalman filter include various powertrain/driveline speeds and torques. One example powertrain configuration is a two electric motor battery electric vehicle (BEV) where the powertrain can be represented through a lumped-parameters model. The looping Kalman filter estimates states, starting from a state (m+a) samples in the past xₑₛₜ(k−m−a), where k is the sample index, m is a number of samples clocked during the measurement delay, and a represents a number of samples clocked during the actuation delay to the current equivalent control time x(k). A supervisory controller also generates reference and constraint values to be followed by an advance controller (e.g., a motor controller).

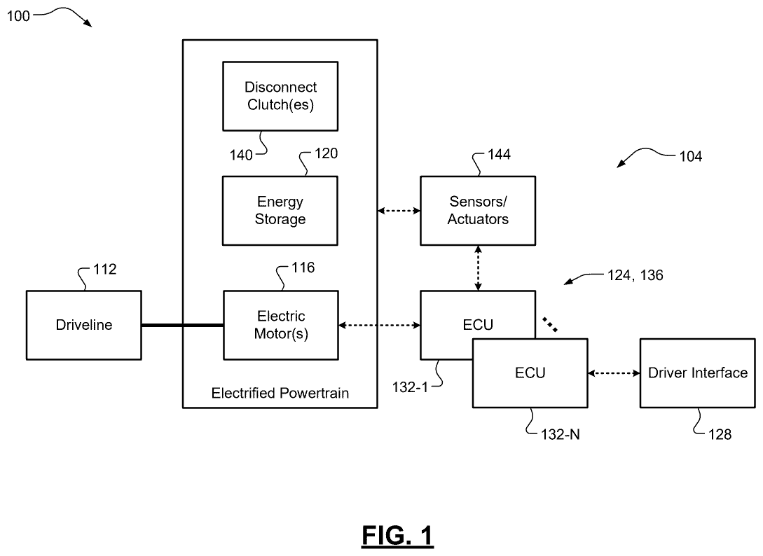

Referring now to FIG. 1, a functional block diagram of an electrified vehicle 100 having an example driveline vibration management system 104 according to the principles of the present application is illustrated. The electrified vehicle 100 (also “vehicle 100” herein) generally comprises an electrified powertrain 108 configured to generate and transfer drive torque to a driveline 112 for propulsion. The electrified powertrain 108 includes one or more electric motors 116 that are powered by electrical energy from an energy supply system 120 (a high voltage battery pack or system, a fuel cell system, or some combination thereof). As shown, the electrified powertrain 108 is a two-motor BEV configuration that only includes two electric motors 116a and 116b, but it will be appreciated that the electrified vehicle 100 could have any suitable electric or hybrid configuration (HEV, PHEV, BEV, etc.) and that the electrified powertrain 108 could also include other non-illustrated components, such as an internal combustion engine (e.g., connected to a motor-generator unit, or MGU, for electrical energy generation).

The electrified vehicle 100 is controlled by a control system 124, which primarily controls the electrified powertrain 108 to generate a desired amount of drive torque to satisfy a driver torque request provided via a driver interface 128 (e.g., an accelerator pedal). The control system 124 can include multiple electronic control units (ECUs) 132-1 . . . 132-N(collectively, “ECUs 132”) that are connected in some manner via a controller area network (CAN) or other suitable network 136. For example, the control system 124 could include a supervisory ECU 132 that supervises one or more secondary ECUs 132, such as a motor controller or motor control ECU 132. The control system 124 is configured to control the electrified powertrain 108 and the driveline 112 to achieve one of a plurality of different states, which could include, for example only, (i) only one electric motor 116a or 116b being connected to the driveline 112 (via an optional one or more disconnect clutch(es) 140), or single-motor drive mode or (ii) both electric motors 116 being connected to the driveline 112, or dual-motor drive mode. For example only, the electric motors 116a and 116b could be connected to separate front and rear axles (not shown) of the driveline 112 as part of electric drive modules (EDMs).

This present application proposes a methodology to overcome delay limitations by leveraging a physics-based model of the electrified vehicle 100 that is used to predict the status of the driveline 112 while adjusting the estimation using data affected by delays (measurement delays, actuation delays, etc.). In the above-described configurations, the driveline 112 presents several components with one or more disconnect clutch(es) 140 along with many torque paths/gear sets that are characterized by stiffness and lash. While operating such driveline is of vital important to reduce potential vibrations within the components to guarantee a desired level of performance, component life, and perceived quality of the electrified vehicle 100. An advance (i.e., future or horizon based) control algorithm or controller can be used to control and compensate potential non-linear behavior of such systems, but these techniques often require the availability of a specific set of information to be able to monitor the current operating condition of the different components.

Unfortunately, as previously discussed, measurement of specific quantities, such as torque across components, would require a very expensive set of torque sensors to be implemented, and, even when specific methodologies to measure such variables are available, the estimation is still affected by delays. These measurement delays can include, for example only, sampling times of a plurality of sensors 144 (e.g., motor/shaft position sensors), dynamics of the sensors 144, communications between the sensors 144 and the various ECUs 132, possible bus delays on the CAN 136 between a particular ECU 132 receiving the raw measurement(s) from the sensors 144 and the control software executed by the particular ECU 132, and possibly sensor/scanner raster rates (e.g., Hall-effect type sensors) and measurement scheduling delays. Delays also affect the actuation, often done through the electric motors 116, that the advance control algorithms require. The corresponding actuation chain can thus have its own set of delays (communication, scheduling, raster, actuation dynamics, etc.) corresponding to the control system 124, the CAN 136, and/or the plurality of actuators 144 (e.g., inverter switches for providing power to actuate the electric motors 116). When dealing with events such as lash transitions and shaft vibrations, small delays within the measurement and actuation systems can quickly accumulates, effectively making a basic advance control methodology useless.

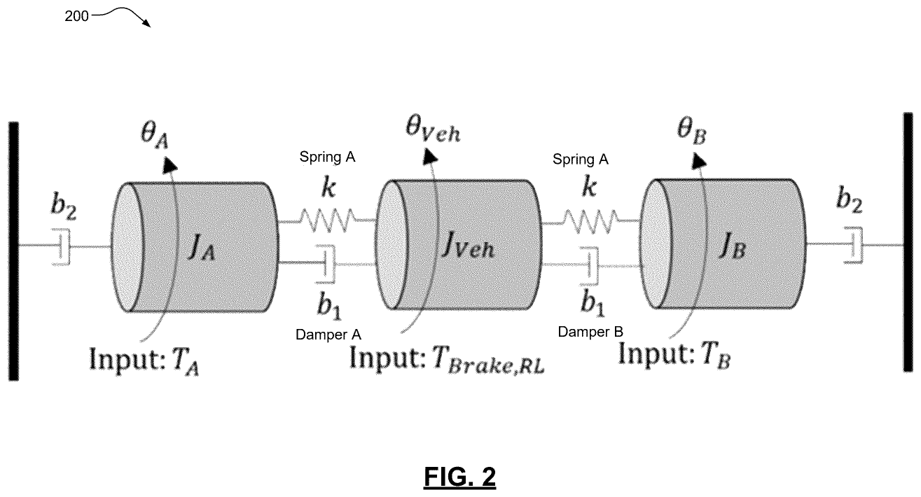

Referring now to FIG. 2 and with continued reference to FIG. 1, to make the problem more evident, we can consider a two motor BEV configuration, in which the electrified powertrain can be represented through a lumped-parameters model 200 as shown. Each electric motor (motor A 116a and motor B 116b) is represented by a respective inertia (J_{A} and J_{B}, respectively) with torques (T_{A} and T_{B}, respectively) acting on the respective inertias. Each electric motor's position is represented by θ_{A} and θ_{B}, respectively. The vehicle's inertia is represented by J_{Veh} with a torque T_{Brake,RL} acting on the vehicle's inertia J_{Veh}. This torque T_{Brake,RL} represents the combination of friction brake torque T_{Brake} and road load torque T_{RL}. The vehicle's position is represented by θ_{Veh}. Finally, the combination of springs and dampers (springs A and B and dampers A, B) that connect the respective electric motor inertias J_{A} and J_{B} to the vehicle inertia J_{Veh} represent the driveline's elasticity.

After some manipulations, we can write the model representing the behavior of the powertrain as a linear system of the form (discrete time):

$$x ( k + 1 ) = A \cdot x ( k ) + B \cdot u ( k ) , \qquad ( 1 )$$

where A represents an state dynamic matrix and B represents an input dynamic matrix, and where k is a sample index. In this case, we consider u to be the control inputs, the two motor torques, T_{A} and T_{B}. The state x is then the following:

$$x = {[ \begin{matrix}{\dot{θ}}_{A} & \dot{{θ}_{B}} & \dot{{θ}_{V}} & {T}_{Spring , A} & {T}_{Spring , B}\end{matrix} ]}^{T} , \qquad ( 2 )$$

where \dot{θ}_{A}, \dot{θ}_{B}, and \dot{θ}_{V} represent speeds of motor A 116a, motor B 116b, and the vehicle 100, respectively, and T_{Spring,A} and T_{Spring,B} represent the torque at the springs A and B, respectively. For the purpose of this application, we can simply focus on the linear formulation:

$$x ( k + 1 ) = A \cdot x ( k ) + B \cdot u ( k ) . \qquad ( 3 )$$

When we want to estimate the dynamic of the actual system, we are interested at the value of the state x at a specific point in time k (in this case, k represents a specific discrete point in time equivalent to a specific sample of time within the respective ECU 132). This means that we are interested to the state x(k).

Because of the above-described measurement delays, the actual measured value arriving at the advanced controller is x(k−m), with m the number of equivalent sampling times that are obtained or “clocked” during the measurement delay. That is, the advance control algorithm executed by the ECU 132 will not have current values, but the values of the system some “measurement delays” in the past. Further, and to make things more complicated, the actuation of the advance control algorithm also goes through an actuation chain with its own set of delays as previously described herein. Therefore, the actuation will influence the dynamic with u(k+a), with a being the number of equivalent sampling times that are obtained or “clocked” during the actuation delay. Therefore, the advance control algorithm is influencing a system with a total loop delay of m+a. When within the actuation and measurement chain, these delays might accumulate to more than, for example only, 50 milliseconds (ms). Lash events, however, can last as little or less than, for example only, 10 ms. Therefore, if the ECU 132 receives and actuates within a 50 ms loop, it will be unable to effectively control the lash traversal.

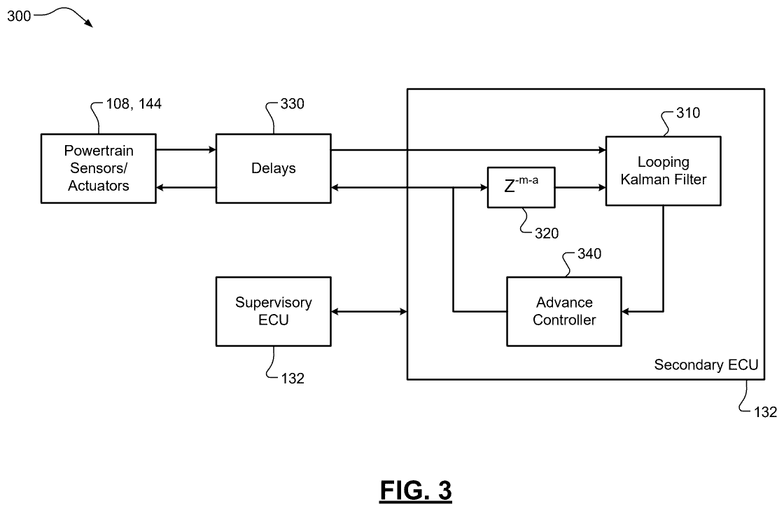

Referring now to FIG. 3 and with continued reference to FIGS. 1-2, a functional block diagram of an example system architecture 300 for the driveline vibration management system 104 according to the principles of the present application is illustrated. The illustrated architecture includes a looping Kalman filter 310, which could be implemented in a motor-specific secondary ECU 132 of the control system 124 (e.g., a motor controller), which could be a part (i.e., a sub-component) of the same supervisory ECU alongside the advance control algorithm, therefore experiencing the same measurement and actuation delay, but there will be no delay are present between the looping Kalman filter and the advance control strategy. The overall strategy based on a basic or conventional Kalman Filter architecture, which is enhanced by using a looping strategy to estimate the dynamic up to a given horizon length (“looking ahead” or “in the future”). To establish how “far in the future” the strategy needs to compute the variables of interest, we consider each stage, starting from the actual current value at the powertrain:

$$x ( k + 1 ) = A x ( k ) + B u ( k ) , and \qquad ( 4 )$$

$$y ( k ) = C x ( k ) . \qquad ( 5 )$$

After the measurement delay m, the current input to the advance controller is the following:

$$x ( k - m + 1 ) = A x ( k - m ) + B u ( k - m ) , and \qquad ( 6 )$$

$$y ( k - m ) = C x ( k - m ) . \qquad ( 7 )$$

This means that, at sample time k of the ECU 132, the ECU 132 receives the states as they were m sample time in the past.

We also need to make sure, however, that we are able to evaluate the dynamics considering also the actuation delay a:

$$x ( k - m - a + 1 ) = A x ( k - m - a ) + B u ( k - m - a ) , and \qquad ( 8 )$$

$$y ( k - m - a ) = C x ( k - m - a ) . \qquad ( 9 )$$

This is the case because the action commanded by the ECU 132 using the estimation will affect the actual system after a sampling times. This means that, for the advance control algorithm to see an equivalent loop time of 0, the estimator needs to predict the dynamic of the system up to m+a samples time in advance. This because, any action from the ECU 132, will take a samples time to arrive at the shaft, then, once there, it will affect the dynamic of the shaft, then, this dynamic, will need m more sample times to arrive back to the ECU 132. So, the total loop time is m+a samples time. Therefore, in order to correctly estimate the dynamic of the system at the current time, we need to use the command from the ECU 132 that was sent at time k−m−a, with the measurements from the sensors 144 at that arrives at the current sampling time in the ECU 132, as that information is relative to what happened in the actual shaft at time k-m, exactly when the command sent from the ECU 132 at time k−m−a arrives to the shaft (e.g., electric motor 116).

As specifically shown in FIG. 3, the looping Kalman filter 310 works as follows. A basic or conventional Kalman filter with measurement feedback correction 320 is used to estimate the dynamic at time k+1-m-a using the following equation:

$${x}_{est} ( k + 1 - m - a ) = A {x}_{est} ( k - m - a ) + B u ( k - m - a ) + L [ {y}_{meas} ( k - m ) - C {x}_{est} \{ k - m - a ) ] . \qquad ( 10 )$$

The estimation of the states at time k−m−a is done using the u that the algorithm would compute for the time k−m−a, and the estimation is corrected using the measurement relative to the time k−m. This means that the latest measurement coming from the powertrain 108 (e.g., the sensors 144) is used as soon as it arrives in the ECU 132 after various delays 330. When the ECU 132 is turned on, the initial state is set to 0 for the first m+a loops, then the value of the state computed in the previous iteration is used to initialize the very beginning of the following loop, for the equivalent sample time (m−a in the current iteration, and m−a+1 in the previous iteration, as the new iteration is +1 sample times in the future compared to the previous iteration).

This guarantees the latest updated state estimation is used to initialize the current iteration:

$${x}_{current} ( m - a ) = {x}_{past} ( m - a + 1 ) , \qquad ( 11 )$$

where x_{current} represents the current iteration and xₚₐₛₜ represents the previous iteration of the Kalman filter looping strategy. After the first update, the rest of the m+a steps of the dynamic are estimated using the model of the dynamic and the relative command for the relative time steps until the current time estimation is reached:

$${x}_{est} ( k + 2 - m - a ) = A {x}_{est} ( k + 1 - m - a ) + B u ( k + 1 - m - a ) , \qquad ( 12 )$$

$${x}_{est} ( k ) = A {x}_{est} ( k - 1 ) + B u ( k - 1 ) . \qquad ( 13 )$$

The current state estimation xₑₛₜ(k) can now be fed to the advance controller 340 of the looping Kalman filter 310. Note that the reason why we stop at the time k and we do not fed the advance controller 340 with estimation of k+a (a steps in the future) to compensate for actuation delays 330, is that typically the advance controller 340 generates offset to the actuators on top of commands sent by a supervisory controller (e.g., another ECU 132 of the control system 124). The supervisory controller 132 also generates reference and constraints for the advance controller 340 to follow. These commands and references will also go through the actuation delays 330, making the advance control synchronized with the rest of the commands sent by the supervisory controller 132. Effectively, the depiction 300 is an accurate representation of the system a steps in the future.

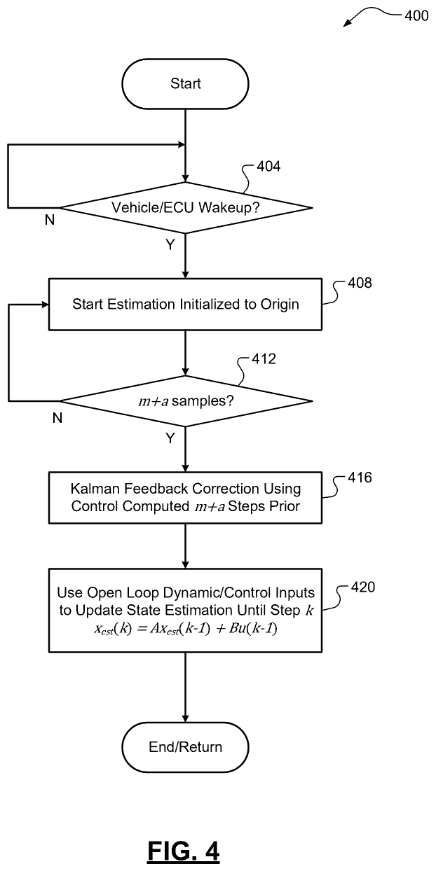

Referring now to FIG. 4 and with continued reference to FIGS. 1-3, a flow diagram of an example looping Kalman filter driveline vibration estimation method 400 for an electrified vehicle according to the principles of the present application is illustrated. While the method 400 specifically references the vehicle 100 and its components for descriptive/illustrative purposes, it will be appreciated that the method 400 could be applicable to any suitably configured electrified vehicle (HEV, PHEV, BEV, etc.). The method 400 begins at 404 where it is determined whether the vehicle 100 or the ECU(s) 132 wakeup. When true, the method 400 proceeds to 408. For example, the supervisory ECU 132 may initially wakeup and then wakeup the other ECUs 132 (e.g., the secondary motor control ECU 132) via the CAN 136 or hardwire wakeup lines. Otherwise, the method 400 ends or returns to 404. At 408, the ECU 132 begins or starts its state estimation of the powertrain/driveline as described herein. This can include beginning the looping Kalman filter and setting the states to zero for the first m+a time samples. At 412, the ECU 132 determines whether the m+a time samples have passed. When false, the method 400 returns to 408. When true, the method 400 proceeds to 416. At 416, the ECU 132 performs Kalman feedback correction using control inputs calculated m+a steps prior or earlier as previously described herein. At 420, the ECU 132 uses the open loop dynamic and control inputs to update the state estimations until step k as previously described herein. The current estimated state for time k can then be estimated as Axₑₛₜ(k−1)+Bu(k−1) similar to a basic or conventional Kalman filter prediction or estimation. This can continue until a subsequent vehicle key-off cycle or other vehicle state change that requires the method 400 to end or restart.

To briefly summarize, previous solutions either (1) ignore the delays affecting both measurement and actuation chains, effectively making the strategy purely theoretical, (2) rely on components which are less affected by transmission delays, such as local controllers within the actuation system, where the information is locally available, or (3) apply control strategy with larger time frames (lower frequency content) where delays can be ignored as they can be considered small compared to the control time dynamic. The first solution (1) is clearly not of use in production vehicles, the second solution (2) uses simple control techniques, as closed-loop PID, due to the often-reduced computational power available to low-level local controllers, and the third solution (3) lacks the adequate resolution to effectively control and compensate for high-frequency vibrations and lash traversal events, rendering this solutions suboptimal. Compared to these previous solutions, the newly-proposed strategy allows to estimate with a high level of accuracy various key quantities necessary for advance control algorithms. This is done while effectively compensating both actuation and measurement delays. This allows the control algorithms to be designed and operate as if the delays were not present, guaranteeing close to optimal performance.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A driveline vibration management system for an electrified vehicle, the driveline vibration management system comprising:
a set of sensors configured to measure parameters of the electrified vehicle, each measured parameter relating to an electrified powertrain and a driveline of the electrified vehicle; and
a control system configured to:
initiate a looping Kalman filter for N time samples, where N is an integer greater than zero and is based on a delay between the control system and the electrified powertrain and the driveline; and
after the N time samples:
utilize the looping Kalman filter to (i) estimate a state of the electrified powertrain and the driveline and (ii) update previous estimate states of the electrified powertrain and the driveline; and
utilize an advance controller to control the electrified powertrain and the driveline based on their respective estimated states.

2. The driveline vibration management system of claim 1, wherein N is based on time sample delays M and A, wherein M represents a number of time samples corresponding to a measurement delay associated with the set of sensors and the control system, and wherein A represents a number of time samples corresponding to an actuation delay associated with the control system and the electrified powertrain and the driveline.

3. The driveline vibration management system of claim 2, wherein M and A are both integers greater than zero and N equals (M+A).

4. The driveline vibration management system of claim 3, wherein the control system is configured to initialize the looping Kalman filter upon wakeup of the electrified vehicle or the control system.

5. The driveline vibration management system of claim 4, wherein the control system is configured to initialize the looping Kalman filter by initializing its estimation to an origin value for the first (M+A) time samples.

6. The driveline vibration management system of claim 5, wherein the origin value is zero.

7. The driveline vibration management system of claim 5, wherein the advance controller is designed to control a system without looping delays and therefore the advance controller needs the looping Kalman filter to compensate for the looping delays.

8. The driveline vibration management system of claim 7, wherein the control system comprises a supervisory electronic control unit (ECU) configured to supervise and provide references using the looping Kalman filter and the advance controller to a secondary ECU, and wherein the secondary ECU is configured to actuated the references from the supervisory ECU and to measure and send information back to the supervisory ECU.

9. The driveline vibration management system of claim 8, wherein the secondary ECU is a motor controller for one or more electric motors of the powertrain.

10. The driveline vibration management system of claim 9, wherein the powertrain includes separate first and second electric motors that are selectively connectable to the driveline to achieve both a single-motor drive mode and a dual-motor drive mode.

11. A driveline vibration management method for an electrified vehicle, the driveline vibration management method comprising:
receiving, by a control system of the electrified vehicle and from a set of sensors of the electrified vehicle, measured parameters of the electrified vehicle, each measured parameter relating to an electrified powertrain and a driveline of the electrified vehicle;
initiating, by the control system, a looping Kalman filter for N time samples, where N is an integer greater than zero and is based on a delay between the control system and the electrified powertrain and the driveline; and
after the N time samples:
utilizing, by the control system, the looping Kalman filter to (i) estimate a state of the electrified powertrain and the driveline and (ii) update previous estimate states of the electrified powertrain and the driveline; and
utilizing, by the control system, an advance controller to control the electrified powertrain and the driveline based on their respective estimated states.

12. The driveline vibration management method of claim 11, wherein N is based on time sample delays M and A, wherein M represents a number of time samples corresponding to a measurement delay associated with the set of sensors and the control system, and wherein A represents a number of time samples corresponding to an actuation delay associated with the control system and the electrified powertrain and the driveline.

13. The driveline vibration management method of claim 12, wherein M and A are both integers greater than zero and N equals (M+A).

14. The driveline vibration management method of claim 13, wherein the control system is configured to initialize the looping Kalman filter upon wakeup of the electrified vehicle or the control system.

15. The driveline vibration management method of claim 14, wherein the control system is configured to initialize the looping Kalman filter by initializing its estimation to an origin value for the first (M+A) time samples.

16. The driveline vibration management method of claim 15, wherein the origin value is zero.

17. The driveline vibration management method of claim 15, wherein the advance controller is designed to control a system without looping delays and therefore the advance controller needs the looping Kalman filter to compensate for the looping delays.

18. The driveline vibration management method of claim 17, wherein the control system comprises a supervisory electronic control unit (ECU) configured to supervise and provide references using the looping Kalman filter and the advance controller to a secondary ECU, and wherein the secondary ECU is configured to actuated the references from the supervisory ECU and to measure and send information back to the supervisory ECU.

19. The driveline vibration management method of claim 18, wherein the secondary ECU is a motor controller for one or more electric motors of the powertrain.

20. The driveline vibration management method of claim 19, wherein the powertrain includes separate first and second electric motors that are selectively connectable to the driveline to achieve both a single-motor drive mode and a dual-motor drive mode.
